(19) United States
(12) Patent Application Publication
(10) Pub. No.: US 2006/0050525 A1
(43) Pub. Date: Mar. 9, 2006

(54) Forensic light source and illumination method

(76) Inventors: Gregoire Verrier, Metuchen, NJ (US); Nicolas Vezard, Edison, NJ (US); Thomas Biczo, Bayville, NJ (US)

Correspondence Address: ROGER PITT;KIRKPATRICK & LOCKHART NICHOLSON GRAHAM LLP, 599 LEXINGTON AVENUE, 33RD FLOOR, NEW YORK, NY, 10022-6030, US

(21) Appl. No.: 11/208,499

(22) Filed: Aug. 22, 2005

Related U.S. Application Data
(60) Provisional application No. 60/603,751, filed on Aug. 23, 2004.

(51) Int. Cl. G02B 6/00

(52) U.S. Cl. 362/551

(57) ABSTRACT

A forensic light source and method using an inventive light source comprising a short arc gas vapor discharge lamp is disclosed. A support structure is provided for supporting the source of light. A light guide having first and second ends, is coupled to the source of light at the first end to receive light from the source of light and transmit the light to the second end. The light guide is mounted on the support structure. A filter support member supports a plurality of filters. A portable hand holdable and movable light directing assembly is mounted on the second end of the light guide. The light directing assembly supports the filter support member and provides for movement of the filter support member to a plurality of positions. Each of the positions corresponds to a coupling of a selected one of the filters to the second end, whereby the light emitted from the second end is filtered by the selected filter while the emitted light is directed to various locations through movement of the light directing assembly. A dc power supply has a pulsating dc or constant voltage output.

### CROSS-REFERENCE TO RELATED APPLICATIONS

This application is a non-provisional filing based on provisional application Ser. No. 60/603,751, filed Aug. 23, 2004 and directed to FORENSIC LIGHT SOURCE, the priority of which is hereby claimed.

### TECHNICAL FIELD

The present invention relates to light sources of the type employed in the forensic examination of treated and untreated objects and surfaces and to a method employing such sources.

### STATEMENT REGARDING FEDERALLY SPONSORED RESEARCH OR DEVELOPMENT

Not applicable.

### BACKGROUND OF THE INVENTION

Light sources have been used for many years in connection with the forensic examination of objects and surfaces, for example those found or located at a crime scene. Typical objectives of such examination are detection and photography of blood, fingerprints, hair, bodily fluids, and other traces which may be used, for example, to associate an object or location with a particular individual.

In order to enhance the detectability and imageability (for example, for the purpose of photography) of trace materials, law enforcement personnel employ a wide range of tools, including fingerprint dusting powder, chemical developers and photography.

Detection of such traces has spawned sometimes elaborate techniques for enhancing the detectability of evidence. For example, in U.S. Pat. No. 4,258,073 to Payne, the surface under examination is electrostatically charged to encourage the deposit of finely divided carbon to enhance a pattern for visual detection.

More conventionally, when a fingerprint is fresh, the oil which forms the print generally follows the pattern of the fingerprint ridges in the finger which made the print. If a fine dust is applied to the surface of a fresh print, the dust tends to adhere to the oils in the fingerprint, thus forming a pattern which generally reveals the pattern of the fingerprint.

Fingerprint dusts were initially selected for their color contrasting qualities as compared to the background. Thus, white dust was used to enhance a fingerprint on a black object and vice versa. Even where the oils of a fingerprint have lost their tackiness due to aging or other phenomena, the amino acids, into which they break down, do cause a minute etching of many surfaces. While this etching is often not visible to the naked eye, and may not become visible with the application of a colored powder, extremely fine fluorescent dusting powders will reveal the fingerprint pattern when illuminated under high intensity light.

One of the chief tools employed by law enforcement officials remains the light source, which started as a simple incandescent flashlight, but now preferably takes the form of vapor arc lamps. Such lamps generally comprise a glass or ceramic bulb. The bulb surrounds a pair of electrodes and defines a chamber. The chamber is filled with a desired material to be vaporized and electrically stimulated into a light emitting state by an electrical arc or plasma positioned adjacent the two electrodes. An electrical current passing through a gaseous vapor which has been excited into a state of conductivity to form a plasma arc has the potential of emitting light with an efficiency which far exceeds that of an incandescent lamp filament. In addition, the potential exists for emission of wavelengths deep into the ultraviolet. Light emitted by such arc vapor lamps may be the direct output of the excited plasma which forms the arc, or it may be a stimulated radiation in a desired range. Such stimulated radiation would be provided by a phosphorescent coating on the inside of the glass bulb, which might, for example, receive ultraviolet radiation and, in response to it, be stimulated to output light in the visible range.

Forensic light sources on the market today predominantly use metal halide and xenon lamps. Both of these lamp types are far superior to the older incandescent light sources, despite the fact that they require specialized power supplies to operate. As compared to a simple battery or a steady voltage/steady current AC mains power supply as used with incandescent lamps, xenon and metal halide lamps require complex power supplies with a high-voltage arc ignition load, lower steady state operating voltage, and very high reignition voltage.

For example, a typical metal halide lamp may require an ignitor voltage of 25,000 volts minimum, in the form of a 1000 pulse per second square wave, for hot reignition. Accordingly, a relatively complex power supply, comprising, for example, an electronic ballast, is needed to power the device. Operation of such lamps is also complicated by the temperature of the lamp, with another typical lamp requiring 20,000 volts to re-ignite when hot and 4500 volts to ignite a cold lamp.

While metal halide lamps are more efficient than, for example, incandescent lamps, the intense light output required by modern forensic techniques makes powering metal halide forensic light sources with battery power substantially impractical.

Notwithstanding the above complications, metal halide lamps, because of their relatively uniform and spectrally complete production of light across the visible spectrum (with some additional output in the infrared and ultraviolet ranges) are generally preferred as lamps in forensic light sources. Metal halide lamps have an output radiation intensity which is greater than other types of lamps used in forensic light sources, particularly in the visible region of the spectrum.

In some cases, it may be desirable to have a very high output of ultraviolet light. When the provision of a relatively high intensity of ultraviolet output is important, xenon arc lamps are the preferred choice for the lamp in a forensic light source. Like metal halide lamps, compared to incandescent lamps, xenon lamps are relatively efficient. However, while xenon lamps have an emission spectrum more like daylight, including substantial emission in the ultraviolet and infrared ranges, their electrical driving requirements are considerably more demanding. Accordingly, xenon source power supplies are heavy and expensive and are impractical in connection with battery power. Moreover, xenon lamps contain materials which are under very high pressure, even when cold and thus present a potentially hazardous situation in the event of bulb breakage.

Recently, improved operation has been achieved through the use of DC electrical sources for lamps in forensic light sources. However, problems respecting poor ultraviolet emission of such lamps (for example those sold under the trademark Cermax), fragility and attendant danger due to bulb breakage, poor efficiency and so forth remain.

### SUMMARY OF THE INVENTION

While, in principle, it is possible to employ a mercury vapor lamp in a forensic light source, the high-pressure of a mercury vapor lamp and its corresponding fragility often limit the employment of mercury vapor lamps to specialized ultraviolet applications, such as the curing of plastics, for example, the ultraviolet curable plastic materials used in dentistry. In accordance with the invention, however, a lamp which contains, when it is operating in its steady state a substantial mercury vapor component, is employed as the light generating element of the inventive forensic light source. The lamp has a short arc length and includes bulb gas components similar to those in halogen lamps.

A forensic light source constructed in accordance with the present invention comprises a source of light comprising a short arc gas vapor discharge lamp. A support structure is provided for supporting the source of light. A light guide having first and second ends, is coupled to the source of light at the first end to receive light from the source of light and transmit the light to the second end. The light guide is mounted on the support structure. A filter support member supports a plurality of filters. A portable hand holdable and movable light directing assembly is mounted on the second end of the light guide. The light directing assembly supports the filter support member and provides for movement of the filter support member to a plurality of positions. Each of the positions corresponds to a coupling of a selected one of the filters to the second end, whereby the light emitted from the second end is filtered by the selected filter while the emitted light is directed to various locations through movement of the light directing assembly. A dc power supply has a pulsating dc or constant voltage output.

The short arc gas vapor discharge lamp may be a Ushio EmArc lamp.

The filter support member may comprise a wheel with a plurality of filters mounted around a point of rotation and the filter support member may further comprise a mounting structure configured to rotatably mount the wheel about the point of rotation. In accordance with the invention, the wheel is positioned to be rotated by a finger of a user. Preferably, the filter support members comprise a mounting structure configured to rotatably mount the wheel about the point of rotation, and the wheel is positioned to be rotated by the thumb of a user. The filter support member comprises a wheel with a plurality of filters mounted around a point of rotation

The filter support member defines a plurality of detentes and a spring member is mounted on the light directing assembly and positioned to releasably engage one of the detentes. Each of the detentes is positioned to correspond to alignment between its respective one of the filters and the second end, when a respective detente is engaged by the spring member. Each of the detentes corresponds to a respective one of the filters.

A heat sink may be coupled to the first end of the light guide. The light guide may be a liquid light guide.

A dc power supply having a pulsating dc or constant voltage output for powering the source of light may use.

In accordance with the invention, the inventive method for the forensic examination of evidence using a light source comprises generating light using a short arc gas vapor discharge lamp. A support structure supports the source of light. A filter support member supports a plurality of filters positioned to receive the output of the source of light. The generating of the light is done by exciting a mixture of mercury, xenon and metal halide in a bulb. The short arc gas vapor discharge lamp is excited with pulsating or smooth substantially direct current, whereby substantially only one electrode is caused to emit light.

In accordance with the inventive method, the light output by the system is filtered to match the expected emission wavelength of a forensic marker material. The evidence may be marked with a material selected from the group consisting of dusting powders, chemicals appliable in liquid form and glues. The generating of light is done by exciting a mixture of mercury, xenon and metal halide in a bulb. The light output by the system is filtered to match the expected emission wavelength of a forensic marker material.

### BRIEF DESCRIPTION OF THE DRAWINGS

Several devices implementing the present invention will be understood from the following description taken together with the drawings, in which:

FIG. 1 is a schematic view of a forensic light source constructed in accordance with the present invention;

FIG. 2 is a schematic view of an alternative forensic light source constructed in accordance with the present invention and employing a plurality of selectable filters for filtering the output of the source;

FIG. 3 is a schematic view of another forensic light source constructed in accordance with the present invention and employing a fiber optic bundle;

FIG. 4 is a top plan view of yet another forensic light source constructed in accordance with the present invention and employing a fiber optic bundle;

FIG. 5 is a front view of the forensic light source of FIG. 4;

FIG. 6 is a side view of the forensic light source of FIG. 4; and

FIG. 7 is a block diagram electrical components of the forensic light source of FIG. 4.

### DETAILED DESCRIPTION OF THE PREFERRED EMBODIMENT

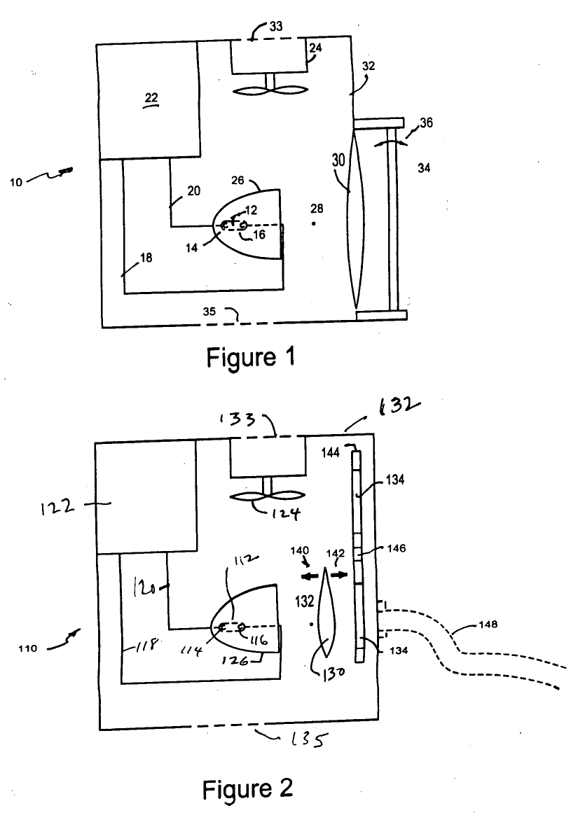

Referring to FIG. 1, a forensic light source constructed in accordance with the present invention is illustrated. The inventive forensic light source 10 comprises a lamp 12. Lamp 12 includes a pair of electrodes 14 and 16 (housed within a clear quartz envelope (or bulb) and is powered by a pair of conductors 18 and 20 housed within the bulb. The bulb of lamp 12 also contains a mixture of mercury, xenon and metal halide.

Power is supplied by a power supply 22, which may be based on battery power, comprising one or more batteries. Alternatively, an AC power supply may be employed and which may be plugged into the alternating current mains. If desired, rechargeable batteries may be employed, and optionally an AC power supply may supply the desired power, and recharge the battery when the battery needs recharging.

The system is cooled by a fan 24 which is also powered by power supply 22. Light output by the system is focused by an elliptical reflector 26 which includes a pair of focal points. One of these focal points coincides with the electrical discharge adjacent electrode 14 which is the electrode which emits light. The other focal point is positioned at point 28, which functions as the source position for a virtual point source which, in turn, may be focused into a converging beam, a diverging beam or a pencil or parallel bundle of any desired width of light by a lens 30. Alternatively, light may be focused onto the input face of a fiber optic bundle as in some of the alternative embodiments described below.

The system is enclosed in a housing 32. Housing 32 may be made of sheet metal, such as steel or aluminum, or any suitable material.

During operation, lamp 12 is powered by power supply 22 and is caused to emit light. Similarly, power is sent to blower 24 which draws air through perforations 33 in housing 32 and exhausts air through perforations 35 in housing 32. This acts to cool the system.

Optionally, the output of the forensic light source may be filtered as it outputs lens 30 by a filter 34. Filter 34 may be tilted, as is known in the art, in the directions indicated by arrows 36 in order to shift the wavelength of output light. Such wavelength shifting will work with an interference filter in accordance with Bragg's law.

In accordance with the invention, lamp 12 is a short arc vapor lamp of the type incorporating a mixture of mercury, xenon and metal halide. When power is supplied to electrodes 14 and 16, an arc is formed between the electrodes and a light emitting plasma generates both heat and light. The generated heat causes the mercury to evaporate, thus insuring an adequate output in the ultraviolet range.

The subject lamp is particularly advantageous in the case of a forensic light source. For example, in the case of a forensic light source, the powering of the device by batteries is of particular importance, as a convenient source of AC current may not be available.

In addition, because of the efficiency provided by the lamp employed in the inventive system, battery life is extended while light output is improved substantially. While such factors may be irrelevant in other circumstances, the use of the inventive system with a battery provides substantial advantages in the context of evidence gathering.

At the same time, because the contents of lamp 12 are not under high-pressure, the likelihood of a dangerous accident is greatly reduced. Again this feature is of particular relevance in the context of a forensic light source, where the area where it is being used may be in disarray and an individual using the same may trip, or the device may be put in a relatively unsecured location from which it may fall, tip over or the like. Such an accident may also result in loss of evidence.

In accordance with the present invention, yet further advantages are provided as compared to prior art systems in as much as lamp 12 is operated with DC current, preferably a battery or relatively smooth DC similar (supplied by a low voltage battery or the AC mains) to the direct current provided by a battery. The result is that the luminous spot is maintained adjacent one electrode 14, which is made coincident with one of the focal points of the elliptical reflector 26. Consequently, light tends to focus at focal point 28 and such focus is relatively distortion free, resulting in the production of good pencils, points and cones at the output of lens 30.

This compares with the situation where both electrodes may emit light and high quality focusing is relatively difficult to achieve.

In accordance with the present invention, the most effective lamp found for use as lamp 14 is a lamp selected from the EmArc series manufactured by Ushio which has offices in California.

These EmArc mercury and metal halide mixture lamps have excellent efficiency and spectral range and are operated with direct current.

Moreover, the advantages of greater output of light, longer battery life, better shaped output and greatly reduced risks of danger due to bulbs exploding is provided without compromising the quality or power output of the lamp.

In the discussion of alternative embodiments below, analogous parts are, where practical, given numbers which are multiples of 100 different from the reference numerals of the elements indicated in connection with the description of the FIG. 1 embodiment.

An alternative embodiment of the light source of the present invention is illustrated in FIG. 2. Alternative light source 110 comprises a power supply 122, which may be based on battery power or on AC power. Alternative light source 110 comprises a lamp 112. Lamp 112 includes a pair of electrodes 114 and 116 and is powered by a pair of conductors 118 and 120.

The system is cooled by a fan 124 which is also powered by power supply 122. Light output by the system is focused by an elliptical reflector 126 which includes a pair of focal points. One of these focal points coincides with the discharge adjacent electrode 114. The other focal point is positioned at point 128, which functions as the source position for a virtual point source which, in turn, may be focused by a lens 130 into a converging beam, a diverging beam, a point on the input face of a fiber optic bundle, or a pencil of light. The system is enclosed in a housing 132. Housing 132 may be made of sheet metal or any suitable material.

During operation, lamp 112 is powered by power supply 122 and is caused to emit light. Similarly, power is sent to blower 124 which draws air through perforations 133 in housing 132 and exhausts air through perforations 135 in housing 132.

Optionally, the output of the inventive forensic light source may be filtered as it outputs lens 130 by any one of several filters 134 mounted for selection on the circumferential edge of a rotatably mounted wheel. Filters 134 may be tilted, as is known in the art, in the directions indicated by arrows 136 in order to shift the wavelength of output light.

Focusing of the system illustrated in FIG. 1 and the system illustrated in FIG. 2 may be achieved by a variety of lens configurations and mechanisms. For example, with reference to the FIG. 2 embodiment, lens 132 may be moved as indicated by arrows 140 and 142. Alternatively, a lens may be omitted from the design.

In contrast to the system illustrated in FIG. 1, light source 110 includes a plurality of filters 134 (for example, six filters) which may be arranged on a wheel 144, which rotates on a hub 146. If desired, wheel 144 may be mounted for tilting to achieve wavelength shifting in the passed wavelength. Wheel 144 may also include an empty hole without a filter for the passage of light without filtering. In addition, if desired, the output of the source may be passed into a fiber optic member 148, mounted in a conventional manner to housing 132.

In using the inventive source, many materials, such as dyes, in addition to fluorescent dusting powders may be used. Inspection of treated and untreated evidence may be done using the specialized light output of the high intensity inventive source and optionally a filter which passes light having a limited range of wavelengths. Depending upon the material used, which material may be either a fluorescent dusting powder, dye, or other marker material, light having a wavelength which substantially coincides with a known excitation wavelength of the marker is employed. The characteristic of the marker is that, upon illumination with light at one of its excitation wavelengths, it will fluoresce, or emit light. Such fluorescence is typically at a longer wavelength as compared to the excitation wavelength.

Examination of evidence may also optionally be enhanced through the use of color filtering glasses or filters, whose color filtering characteristics are tuned to maximize the image to be detected. As noted above, the excitation wavelength is varied through the use of filters at the source. While such devices are very efficient in filtering light, every filter has its own fixed characteristics. These include its center wavelength, bandwidth and transmission coefficient. Thus, if one wishes to have flexibility, the embodiment of FIG. 2, including filter tilting and a wheel of filters and an open hole is of particular value. Moreover, as new dyes and powders are introduced, appropriate filters may be selected and tilted as necessary. The possibility also exists to change a filter wheel or the filters in a wheel.

As can be seen from the above, numerous advantages are provided by the inventive, efficient, superiorly focused, fuller ranged and versatile system. Naturally, the inventive system is advantageous in having the possibility of very high intensity output light at a selected wavelength. Moreover, the same is achieved without increased power consumption and excessive heat energy, which would otherwise stress the rest of the system.

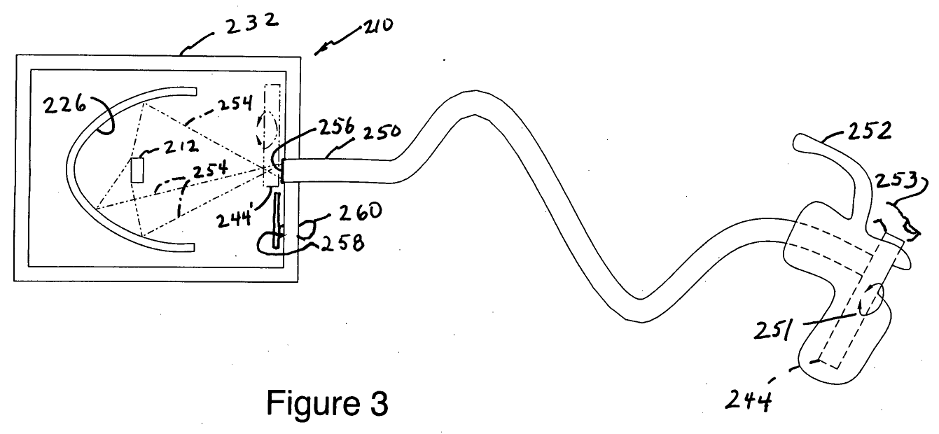

Referring to FIG. 3, in accordance with the invention, a forensic source 210 may take the form of a housing 232 containing a lamp 212 (of the type sold by Ushio under the EmArc trademark with optics substantially arranged as in the embodiments of FIGS. 1 and 2. The output of lamp 212 is coupled to a fiber-optic bundle 250, with wavelength selection performed by a selected filter on a filter wheel 244 (or a pair of filter wheels) which are positioned at the end of fiber optic bundle 250. Filter wheel 244 comprises a generally circular member within which a plurality of filters are mounted at the circumferential periphery of the wheel.

Filter wheel 244 is mounted for rotation in the directions indicated by arrows 251, and may be rotated by the thumb 253 of a user grasping a handle 252 with his hand. This can be most convenient because handle 252 is at the output end of fiber optic bundle 250. Alternately, filters located in a filter wheel 244′ (illustrated in phantom lines in FIG. 3) may instead be located in housing 232 and controlled by direct mechanical linkage or a remote-control at the output of fiber optic bundle 250. Light rays 254 emitted by lamp 212 are focused by reflector 226 onto the input face 256 of fiber optic bundle 250.

Other alternatives are the placement of a battery power supply externally (for example, a battery pack or linkage to a car battery) or use of a removable AC power supply that has a dedicated position in a compartment located in forensic source 210. A mechanical shutter 258 may be mounted for sliding, rotary, or other motion to be positioned over input face 256 of fiber optic bundle 250 to block the output of light from the system. Such motion may be achieved using a knob 260.

The system may also employ band reject filters on a filter wheel. Similarly, goggles (bandpass and/or band reject) may be employed in connection with the inventive forensic light source.

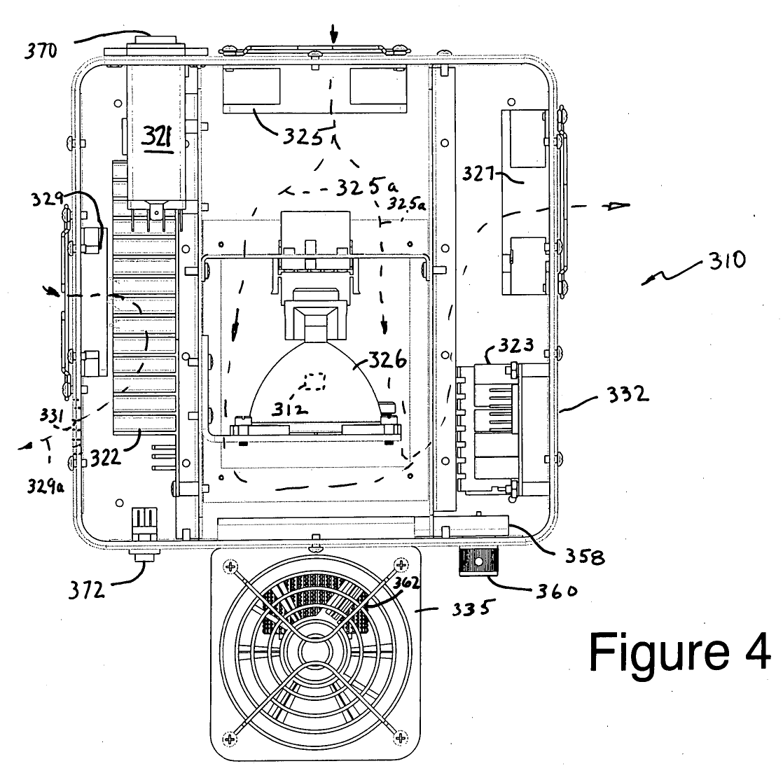

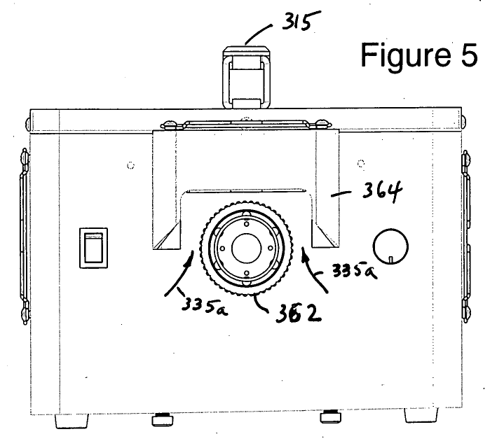

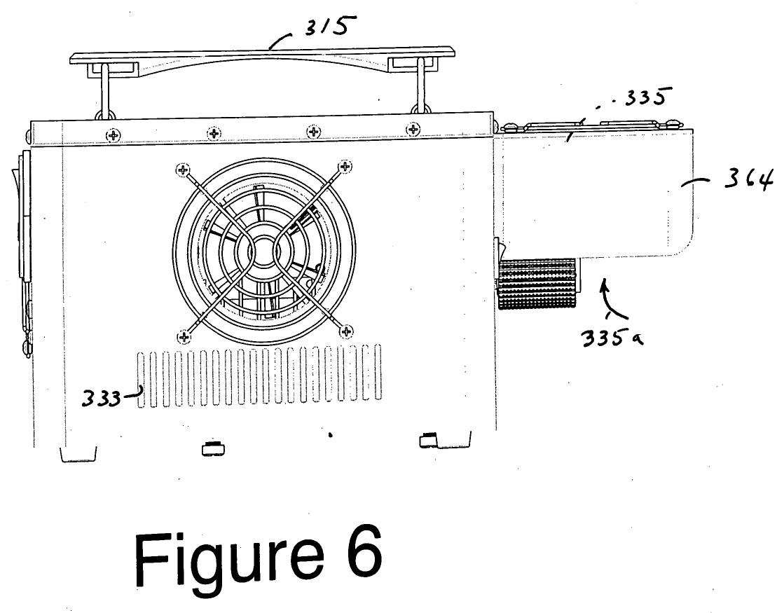

Referring to FIGS. 4-6, an embodiment of the inventive forensic light source 310 is illustrated. Source 310 comprises a lamp 312 contained within an elliptical reflector 326. The lamp is of the type described in connection with the embodiments of FIGS. 1-3. Likewise, the optics in connection with which lamp 312 is used may be substantially the same as those described in connection with the embodiments of FIGS. 1-3. The system may be grasped and carried around by a handle 315.

A fuse assembly 321 (which also includes conventional electrical fluctuation filtering circuitry) supplies power to a 200 watt power supply 322, comprising an electronic ballast which powers lamp 312, whose light emitting electrode is schematically indicated in phantom lines in the figure. Lamp 312 is housed in reflector 326. A second power supply 323 powers a plurality of blowers or fans which cool the unit. These fans are mounted over holes in housing 332 to permit the intake or exhaust of air to form a desired cooling airflow. More particularly, the inventive system comprises a fan power supply 323 which supplies power to an intake fan 325. Intake fan 325 draws air along path 325a through an exhaust fan 327, cooling the lamp and power supply 323.

An intake fan 329 draws air along path 329a and exhausts it through holes 331. Fan 335 draws air in the direction of path 335a, cooling a coupling 362 within which a fiber optic light guide bundle, such as that illustrated in the earlier embodiments, may be mounted. Fan 335 has its airflow guided and concentrated by a cowl 364, which extends around coupling 362. Coupling 362 may be made of metal, such as a lightweight aluminum or other similar alloy. The use of lightweight aluminum has the additional advantage of providing for effective transfer of heat generated at the face of the fiber optic bundle to the cooling airflow.

Light may be blocked by a mechanical shutter 358 operated by a knob 360. The system may be turned on and off by a switch 370. In similar fashion, a secondary switch 372 may be used to turn the lamp on and off.

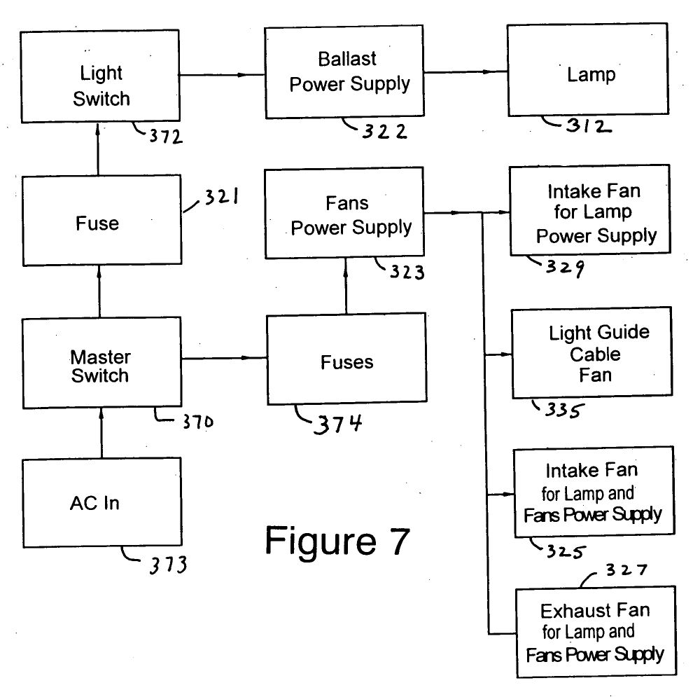

Referring to FIG. 7, the system is powered by the AC mains 373. Power to ballast power supply 322 is coupled by switch 372 to drive lamp 312. More particularly, switch 370 couples power via fuse 321, which provides power to switch 372. Switch 370 also couples power to a suitable fuse arrangement 374, which in turn couples power to power supply 323. Power supply 323 powers fans 325, 327, 329, and 335.

The various parts of the inventive light source 310 are contained in a housing 332. Numerous vent holes, including vent holes 331 and 333 are provided in housing 332.

Filters may be provided in the system as described in connection with the embodiments of FIGS. 1-3, and as discussed above.

While an illustrative embodiment of the invention has been described, it is, of course, understood that various modifications will be apparent to those of ordinary skill in the art. Such modifications are within the spirit and scope of the invention which is defined and limited only by the appended claims.

I claim:

1. A forensic light source, comprising:
(a) a source of light comprising a short arc gas vapor discharge lamp;
(b) support structure for supporting said source of light;
(c) a light guide having first and second ends, said light guide being coupled to said source of light at said first end to receive light from said source of light and transmit said light to said second end, said light guide being mounted on said support structure;
(d) a filter support member supporting a plurality of filters;
(e) a portable hand holdable and movable light directing assembly mounted on said second end of said light guide, said light directing assembly supporting said filter support member and providing for movement of said filter support member to a plurality of positions, each of said positions corresponding to a coupling of a selected one of said filters to said second end, whereby said light emitted from said second end is filtered by said selected filter while the emitted light is directed to various locations through movement of said light directing assembly; and
(f) a dc power supply having a pulsating dc or constant voltage output.

2. A forensic light source as in claim 1, wherein said short arc gas vapor discharge lamp is a Ushio EmArc lamp and said filter support member comprises a wheel with a plurality of filters mounted around a point of rotation and said filter support members further comprises a mounting structure configured to rotatably mount said wheel about said point of rotation, and said wheel is positioned to be rotated by a finger of a user.

3. A forensic light source, as in claim 1, wherein said filter support member defines a plurality of detentes and a spring member is mounted on said light directing assembly and positioned to releasably engage one of said detentes, each of said detentes being positioned to correspond to alignment between its respective one of said filters and said second end, when a respective detente is engaged by said spring member, each of said detentes corresponding to a respective one of said filters.

4. A forensic light source as in claim 1, further comprising a heat sink coupled to said first end of said light guide.

5. A forensic light source as in claim 7, wherein said light guide is a liquid light guide.

6. A forensic light source, comprising:
(a) a source of light comprising a short arc gas vapor discharge lamp;
(b) support structure for supporting said source of light; and
(c) a filter support member supporting a plurality of filters positioned to receive the output of said source of light.

7. A forensic light source as in claim 6, further comprising:
(d) a dc power supply having a pulsating dc or constant voltage output for powering said source of light.

8. A forensic light source as in claim 6, wherein said short arc gas vapor discharge lamp is a Ushio EmArc lamp.

9. A forensic light source as in claim 8, wherein said filter support member comprises a wheel with a plurality of filters mounted around a point of rotation and said filter support members further comprises a mounting structure configured to rotatably mount said wheel about said point of rotation, and said wheel is positioned to be rotated by a finger of a user.

10. A forensic light source, comprising:
(a) a source of light comprising a short arc gas vapor discharge lamp;
(b) support structure for supporting said source of light;
(c) a light guide having first and second ends, said light guide being coupled to said source of light at said first end to receive light from said source of light and transmit said light to said second end, said light guide being mounted on said support and structure; and
(d) a power supply.

11. A forensic light source as in claim 10, wherein said power supply is a dc power supply having a pulsating dc or constant voltage output.

12. A method for the forensic examination of evidence using a light source, comprising:
(a) generating light using a short arc gas vapor discharge lamp;
(b) support structure for supporting said source of light; and
(c) a filter support member supporting a plurality of filters positioned to receive the output of said source of light.

13. A method as in claim 12, wherein said generating of the light is done by exciting a mixture of mercury, xenon and metal halide in a bulb.

14. A method as in claim 12, wherein said short arc gas vapor discharge lamp is excited with pulsating or smooth substantially direct current, whereby substantially only one electrode is caused to emit light.

15. A method as in claim 12, wherein light output by the system is filtered to match the expected emission wavelength of a forensic marker material.

16. A method as in claim 15, wherein said evidence is marked with a material selected from the group consisting of dusting powders, chemicals appliable in liquid form and glues.

17. A method as in claim 12, wherein said generating of light is done by exciting a mixture of mercury, xenon and metal halide in a bulb.

18. A method as in claim 17, wherein light output by the system is filtered to match the expected emission wavelength of a forensic marker material.

19. A forensic light source, comprising:
(a) a source of light comprising a gas vapor discharge lamp having a mixture of mercury, xenon and metal halide;
(b) support structure for supporting said source of light; and
(c) a filter support member supporting a plurality of filters positioned to receive the output of said source of light.
